(19) United States
(12) Patent Application Publication
(10) Pub. No.: US 2021/0002838 A1
(43) Pub. Date: Jan. 7, 2021

(54) HIGHWAY SOUND BARRIER SYSTEM

(71) Applicant: Phoenix Foam Manufacturing, LLC, Grand Rapids, MI (US)

(72) Inventor: Michael E. Arndt, Grand Rapids, MI (US)

(73) Assignee: Phoenix Foam Manufacturing, LLC

(21) Appl. No.: 17/026,635

(22) Filed: Sep. 21, 2020

Related U.S. Application Data
(60) Provisional application No. 62/928,672, filed on Oct. 31, 2019.

(51) Int. Cl. E01F 15/08; G10K 11/16

(52) U.S. Cl. CPC E01F 15/086; G10K 11/16

(57) ABSTRACT

A highway sound barrier system that uses a plurality of foam panels that are joined with an upright member assembly. The foam panels use a foam core and exterior weather protection compounds allowing the system to dramatically reduce transportation, handling and installation costs while increasing the lifecycle of the barrier system and reducing long term maintenance requirements. Moreover, the foam panels include rotatable joints allowing the wall to be easily adjusted to facilitate various landscape parameters and provide for rapid construction.

### FIELD OF THE INVENTION

This invention relates to noise abatement systems and more particularly to highway noise barriers used to reduce noise from vehicle traffic.

### BACKGROUND

Throughout the world highway systems are commonly used by the population for commercial and personal transportation. North America and indeed throughout the world these highway noise barriers are utilized to reduce unwanted truck and automobile noise from reaching residential areas.

Current wall designs used for noise abatement have not evolved much in the last 70 years. Typically, these high noise barriers are made of concrete or concrete mixtures but have sometimes also been made of steel, wood or other masonry products. The problem in using these materials is that they are expensive, often hard to use, are not entirely effective in reducing noise in a highway environment, and the manufacturing of the materials is very environmentally hard on the earth. Accordingly, revolutionary and more sustainable solutions are needed to address current issues with barriers used to provide noise abatement.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention

FIG. 1 illustrates a foam wall assembly used in the highway sound barrier system showing multiple possible rotations according to an embodiment of the invention.

FIG. 2A illustrates and example of a “fan assembly” at a 0-degree rotation showing the angular capabilities of the invention

FIG. 2B illustrates and example of a “fan assembly” at a 5-degree rotation showing the angular capabilities of the invention

FIG. 2C illustrates and example of a “fan assembly” at a 7.5-degree rotation showing another angular capability of the invention

FIG. 2D illustrates and example of a “fan assembly” at a 10-degree rotation showing another angular capability of the invention

FIG. 3, FIG. 3A and FIG. 3B illustrate a 3-tier wall assembly and a single foam panel with the coating shown in the transparent view shown in FIG. 3B.

FIG. 4A, 4B, 4C, and 4D are end views of the panel shown in FIG. 3 illustrating possible types of panel connections.

FIG. 5, FIG. 5A and FIG. 5B illustrate elevated views showing possible male and female spine connections used in a foam assembly.

FIG. 5A and FIG. 5B are magnified views of the spline connections shown in FIG. 5.

FIG. 6A, 6B ,6C and 6D illustrate various embodiments of an upright member assembly as used in the invention.

FIG. 7, FIG. 7A and FIG. 7B illustrate details of a support bracket that may be used in lieu of footings under the cross-members.

FIG. 8A, FIG. 8B and FIG. 8C illustrate alternative embodiment of the invention showing various footing designs that may be used under the cross-members and the support bracket shown in FIG. 7.

FIG. 9A, FIG. 9B and FIG. 9C illustrate various versions of the constructed wall assembly that may be used depending on terrain conditions.

### DETAILED DESCRIPTION OF THE PREFERRED EMBODIMENT

Before describing in detail embodiments that are in accordance with the present invention, it should be observed that the embodiments reside primarily in combinations of method steps and apparatus components related to a highway sound barrier system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element

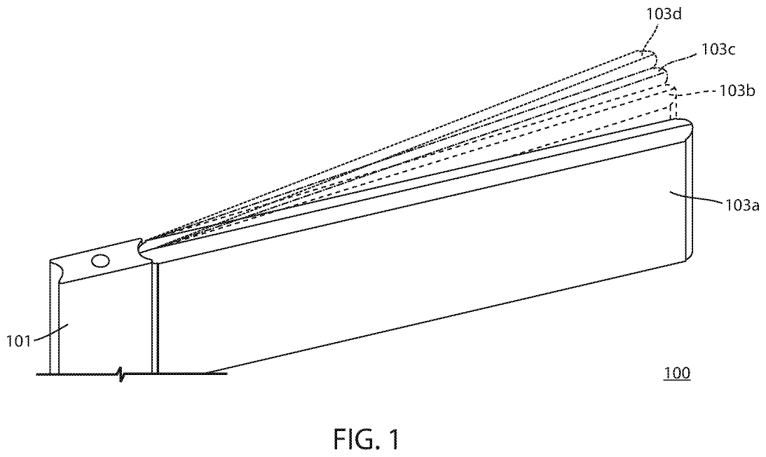

FIG. 1 illustrates a highway sound barrier system 100 consisting of an upright member 101 where one cross-member 101a, 101b, 101c, 101d is shown in various angled orientations. More specifically, the cross-member is shown in a 0-degree, 5-degree, 7.5-degree, and 10-degree rotated position respectively. Those skilled in the art will recognize that any degree rotation of the cross-member from 0-degree to +/−10-degree is possible allowing for an infinite number of angular rotations allowing the system to conform to design requirements.

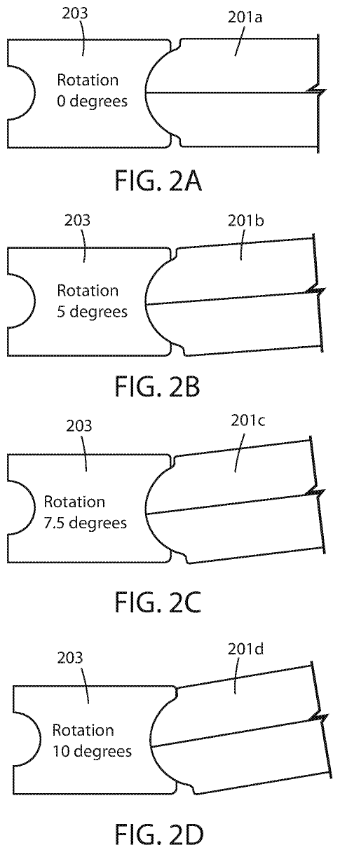

FIG. 2A, FIG. 2B, FIG. 2C, and FIG. 2D are top views illustrating various examples of the barrier system set at in a range 0 to 10-degree rotation showing the angular capabilities of the invention. FIG. 2A shows cross member 201a set at 0-degrees in relation to upright member 203. FIG. 2B shows cross-member 201b set at 5-degrees in relation to upright member 203. FIG. 2C shows cross-member 201c set at 7.5-degrees in relation to the upright member 203. Finally, FIG. 2D shows cross member 201d set at 10-degrees in relation to the upright member 203.

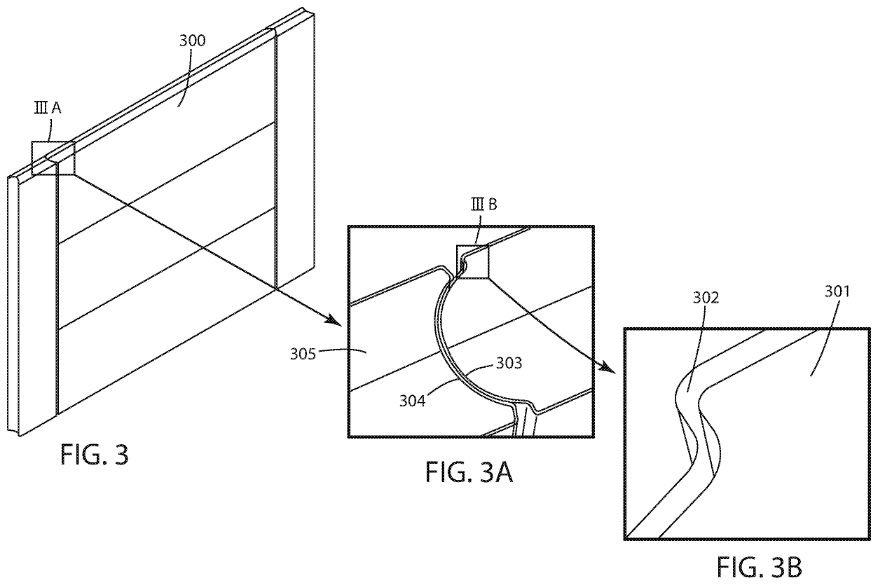

FIG. 3, FIG. 3A and FIG. 3B illustrate a 3-tier wall assembly and a single foam panel with the coating shown in a transparent view as seen in FIG. 3. FIG. 3A shows a cross-sectional view through lines IIIA-IIIA shown in FIG. 3. FIG. 3B shows a cross-sectional view shown though lines shown in FIG. 3A. As seen in both FIG. 3 and FIG. 3A, the cross-sectional shape allows the cross-members to nest into each other forming a strong bond. The required overall length of each cross-member is determined by particular design requirements with typical lengths ranging from 1 to 12 feet or more. More specifically, the foam panel 300 includes an inner core 301 and outer core 302 having a tongue end 303 that inserts into a groove end 304 on the upright member 305. The use of tongue and groove allows the foam panel to be used as an adjustable wall assembly.

As described herein, the outer core 302 typically is specified as needed to coat the foam inner core 301 and provides additional sound attenuation and durability. The interior core 301 is comprised of expanded or extruded polystyrene foam with the required density as per design criteria. The outer core 302 is typically comprised of a strong and durable single or multi-part polyurea type compound with a thickness as required by design. This compound minimizes damage and deterioration under exposure to moisture, ultraviolet radiation, ozone, and other harsh environmental conditions.

Those skilled in the art will recognize that each cross-member may be set with or without a sealant or adhesive between them as required by design and or Federal and State building codes. Since the attachment point on the horizontal mating surfaces between each cross-member consists of a “tongue and groove” type feature, this prevents lateral movement and hinders sound transmission between them. Although shown as a sloped surface, the tongue and groove design may be a radiused, square, rectangle, pyramid, shaped or doweled as determined by design.

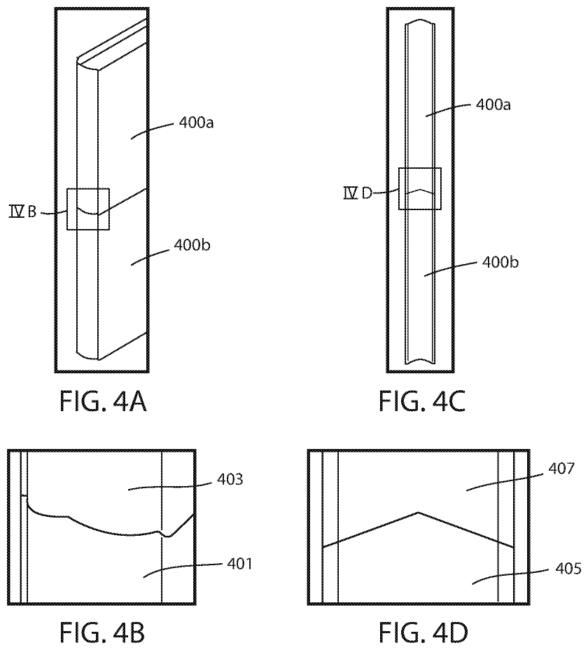

FIG. 4A illustrates a perspective view of stacked foam cross member panels 400a/400b as used in embodiments of the invention. FIG. 4B is a magnified perspective view of a male spine 401 mated with a female spine 403 used to stack foam panels. FIG. 4C is an end view of the foam panel. FIG. 4D is a zoomed in end view showing the male 405 and female spline 407 as used in the foam panel. Those skilled in the art will recognize that the end shape of the cross-member 400 is designed with a radius, allowing a plus/minus i.e. +/−10-degree rotation of various cross-member assemblies to accommodate design needs in the field.

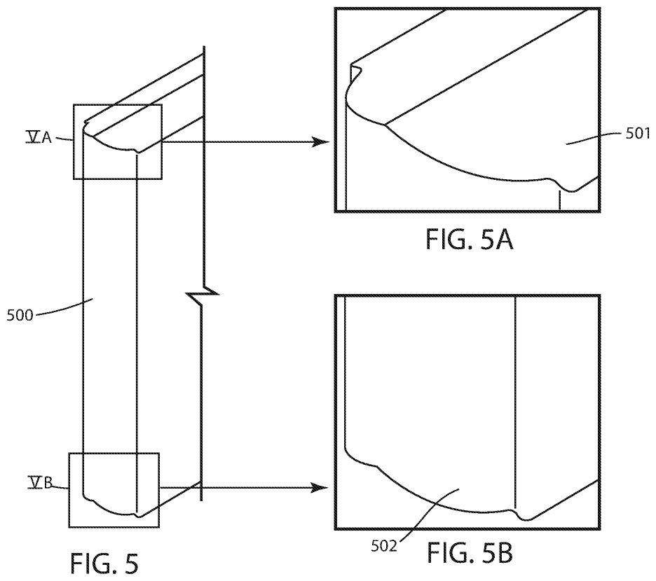

FIG. 5, FIG. 5A and FIG. 5B illustrate elevated views showing male and female spine connections used in a foam panel. More specifically, FIG. 5A and FIG. 5B are magnified views of the top and bottom sections respectively shown in FIG. 5. FIG. 5A shows the contour of the top section 501. FIG. 5B shows the contour of the bottom section 502.

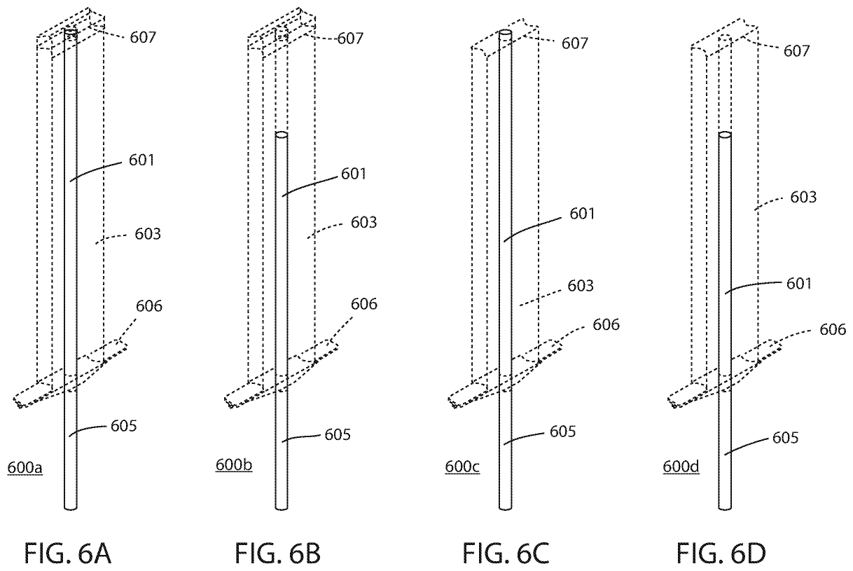

FIG. 6A, 6B, 6C and 6D illustrate transparent views showing various embodiments of an upright member assembly used with various embodiments of the invention. FIG. 6A illustrates an upright member assembly 600a where the upright support 601 extends through the upright member 603. The upright member 603 uses an in-ground support member 605 having a support bracket 606 for providing additional support under the cross members. In this embodiment, a top cap 607 is fitted at the top of the upright member 603. FIG. 6B illustrates an upright member assembly 600b where the upright support 601 extends only through a portion of the upright member 603 and does not extend to the cap 605 at the top of the structure. FIG. 6C illustrates an upright member assembly 600c, where the upright support 601 extends through upright member 603 and extends through the top of the upright member 603. In this embodiment, the upright member 601 is shown exposed above the cross-member. Finally, in FIG. 6D, illustrates an upright member assembly 600d where the upright support extends only partially through the upright member 603 and no cap is shown at the top of the upright member 603.

Thus, in each of FIGS. 6A though FIG. 6D, the upright member 603 extends through a hole through the center of a self-supporting ledge. The upright member 603, can be formed of a post or pole of any shape, and can be hollow or solid such that the diameter and shape is determined by the design. Those skilled in the art will recognize that the upright member 603 has a post and/or panel-type form factor where its interior core uses expanded or extruded polystyrene foam. It may consist of one solid piece or multiple pieces of foam that are bonded together to form the post. At the core of the upright member assembly 600, a hole is used having a round or square shape as required, to allow an upright support member 601 in the form of a structural pole to be inserted to full or partial height as required. As noted herein, the upright member 601 such as a pole can be connected to a second pole and/or footing that is cemented into the ground.

The overall height is also determined during design and will depend on wall height. In other embodiments, the upright member 601 may consist of multiple stacked poles or can be one contiguous section. In use, these poles can be assembled on top of the bottom-most pole that is cemented into the ground. An optional support ledge can be used if desired in order to support the weight of the cross-members without the need for special footings or foundations. The support ledge can be made from ferrous, non-ferrous, or molded plastic materials as required.

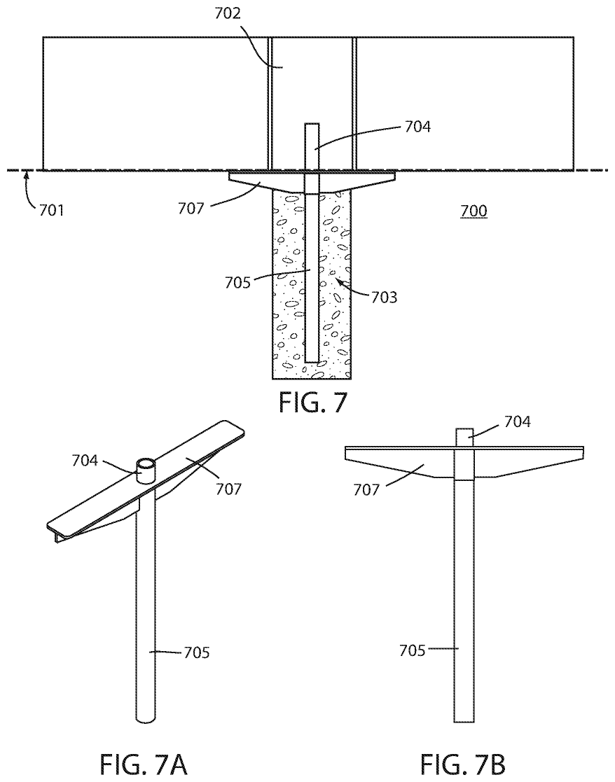

FIG. 7, FIG. 7A and FIG. 7B illustrate an support bracket assembly 700 that is located below ground level 701 and is typically positioned within a round bored concrete pier footing 703. An upright member assembly 700 includes a support pole or pipe 705 holding the assembly securely below ground level. An above ground upright support 704 is used to extend into the upright member 702. An in-ground pipe 705 is attached to and extends below the support bracket 705. A self-supporting ledge 707 may be used in lieu of any footings under the upright member 702.

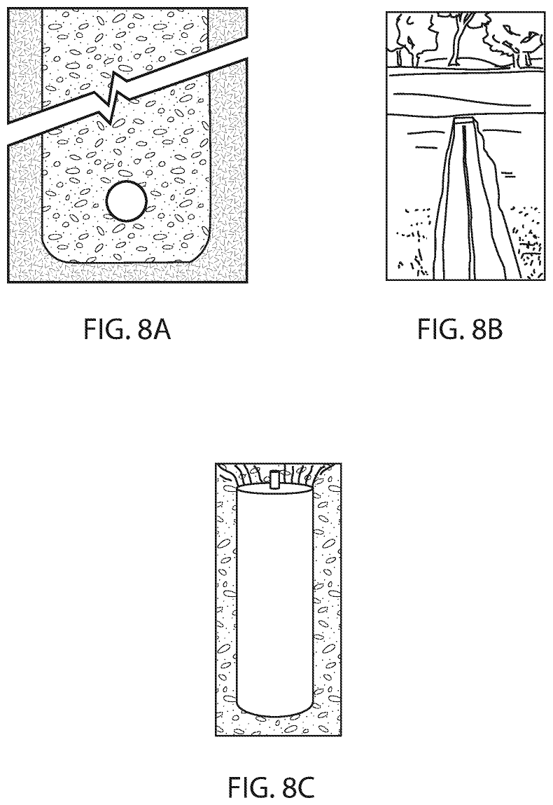

Finally, FIG. 8A, FIG. 8B and FIG. 8C illustrate various footing designs that may be used under the cross-members and the support bracket shown in FIG. 7. FIG. 8A is a sectional view illustrating a pea rock trench foundation. FIG. 8B is an elevated view illustrating a poured concrete trench foundation. Finally, FIG. 8C is an elevated view illustrating a poured concrete pier foundation which is a preferred embodiment of the invention. By nature of these designs, the cross-members, like that shown in FIG. 7, may be sitting on top of a self-supporting ledge 707 and require no special footing and/or foundation requirements. Those skilled in the art will recognize that there are multiple options for foundations if design requirements dictate that they are needed.

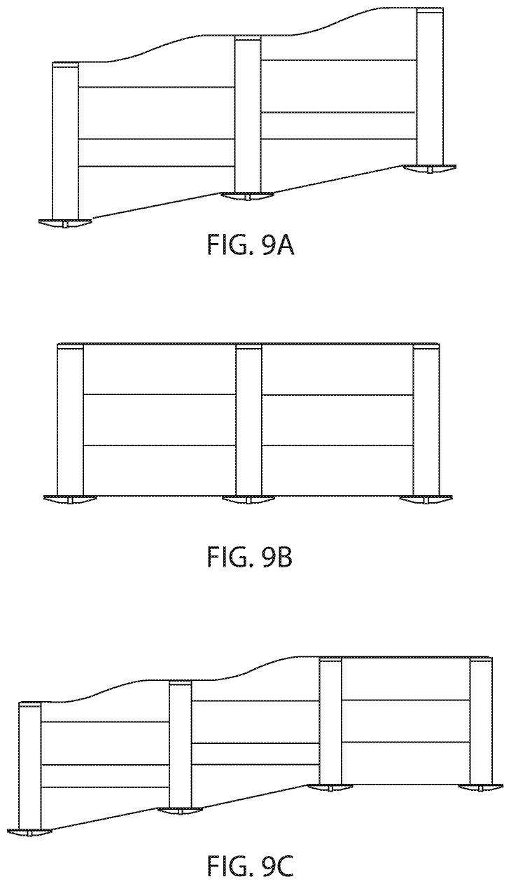

FIG. 9A, FIG. 9B and FIG. 9C illustrate various versions of the constructed wall assembly that are be used depending on terrain conditions at the installation location. More specifically, FIG. 9A shows an assembly that is used with sloped and/or hilly terrain. FIG. 9B shows an assembly used with flat terrain. Finally, FIG. 9C shows an assembly used where there a transition from flat to sloped terrain.

Those skilled in the art will recognize that the objectives of this invention are to substantially reduce material construction cost, reduce shipping, handling, and installation costs. Moreover, its attributes are focused on how the wall itself is constructed e.g. an expanded or extruded polystyrene core coated with a durable shell, how the wall is assembled viz. using multiple interlocking wall panels and its use of an upright member assembly and the type of support bracket/footer. Further the wall assembly has the ability to be adjusted angularly because of the joint connection between the wall panel ends and the main upright member assembly. Further, the foam sound barrier as described herein reduces on-site installation costs and substantially reduces long-term maintenance costs and utilizes 100% recyclable materials.

In the foregoing specification, specific embodiments of the present invention have been described. However, one of ordinary skill in the art appreciates that various modifications and changes can be made without departing from the scope of the present invention as set forth in the claims below.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A foam highway sound barrier system comprising:
a plurality of foam panels each having an interior core and covered in an exterior material;
wherein a plurality of the at least one foam panels are joined to form a wall whose shape is adjustable though the use of rotatable joints at the side of each panel.

2. A foam highway sound barrier system as in claim 1, where the plurality of foam panels are joined together using an upright member assembly.

3. A foam highway sound barrier system as in claim 2, wherein the upright member assembly includes a hole through its core to accept a structure pole.

4. A foam highway sound barrier system as in claim 3, wherein the upright member assembly includes a T-shaped bracket for securing at least one of the plurality of foam panels.

5. A foam highway sound barrier system as in claim 1, wherein the at least one joint is moveable in a range from 0 to +/−10 degrees.

6. A foam highway sound barrier system as in claim 1, where the interior core of the foam panel is comprised of expanded polystyrene foam with a predetermined density.

7. A foam highway sound barrier system as in claim 1, where the interior core of the foam panel is comprised of extruded polystyrene foam.

8. A foam highway sound barrier system as in claim 1, wherein the exterior material of the foam panel is comprised of a polyurea type compound.

9. A foam highway sound barrier system comprising:
at least one upright member having a T-shaped support bracket for securing within the ground;
a plurality of foam panels each attached to the at least one upright member assembly and each having an interior core and covered in an exterior material; and
wherein a plurality of the at least one foam panels are joined to form a wall whose shape is adjustable though the use of at least one rotatable joint at the side of each panel.

10. A foam highway sound barrier system as in claim 9, wherein the at least one upright member assembly includes a hole through its core to accept a structure pole.

11. A foam highway sound barrier system as in claim 9, wherein the at least one rotatable joint moves in a range from 0 to +/−10 degrees.

12. A foam highway sound barrier system as in claim 9, where the interior core of the foam panel is comprised of expanded polystyrene foam with a predetermined density.

13. A foam highway sound barrier system as in claim 9, where the interior core of the foam panel is comprised of expanded polystyrene foam with a predetermined density.

14. A foam highway sound barrier system as in claim 9, wherein the exterior material of the foam panel is comprised of a polyurea type compound.

15. A foam highway sound barrier system comprising:
at least one upright member assembly having a hole longitudinally though its core for securing the at least one upright member to a pole fastened within the ground;
a plurality of foam panels each attached to the at least one upright member assembly and each having an interior core and covered in an exterior material; and
wherein a plurality of the at least one foam panels are joined to form a wall whose shape is adjustable though the use of at least one rotatable joint movable in a range from 0 to +/−10 degrees at the side of each panel.

16. A foam highway sound barrier system as in claim 15, wherein the upright member assembly includes a T-shaped bracket at one end for securing at least one of the plurality of foam panels.

17. A foam highway sound barrier system as in claim 15, wherein the at least one joint is moveable in a range from 0 to +/- 10 degrees.

18. A foam highway sound barrier system as in claim 15, where the interior core of the foam panel is comprised of expanded polystyrene foam with a predetermined density.

19. A foam highway sound barrier system as in claim 15, where the interior core of the foam panel is comprised of extruded polystyrene foam with a predetermined density.
